(19) United States
(12) Patent Application Publication
(10) Pub. No.: US 2006/0265262 A1
(43) Pub. Date: Nov. 23, 2006

(54) Distributed conference scheduling

(75) Inventors: Nirav A. Kamdar, Redmond, WA (US); Senthil K. Velayutham, Sammamish, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/132,726

(22) Filed: May 18, 2005

(51) Int. Cl. G06F 9/46

(52) U.S. Cl. 705/8

(57) ABSTRACT

A conference room endpoint facility enables a user to schedule conferences directly with the conference room endpoint facility without the need for a central data store to save the conference-specific information. For each scheduled conference, the conference room endpoint facility may store the conference data in a blob, and the lob is stored locally with each invited conference attendee. At the time of joining a scheduled conference, each attendee presents its copy of the blob containing the meeting data to the conference room endpoint facility. The conference room endpoint facility validates the conference data and, upon validating the conference data, admits the submitting conference attendee into the conference.

### TECHNICAL FIELD

The described technology is directed generally to communications systems and, more particularly, to techniques for distributed conference scheduling.

### BACKGROUND

With the proliferation of computers and the advent of the Internet, and in particular, the maturing of the World Wide Web (“web”), real-time conversations between conversation participants via their computer systems are becoming increasingly common. These conversations, which take place virtually over computer networks, are ever replacing the traditional face-to-face meetings.

Web conferencing applications are increasingly being used to conduct these virtual meetings. Typically, a person wanting to conduct a meeting, also referred to as a “presenter” in the meeting, schedules a meeting with a conferencing server that hosts the conferencing application that provides the conferencing services. The conferencing server includes, among other components, a reservation system and a data store. When a person utilizes a client application to schedule a meeting with the conferencing server, the reservation system coordinates the scheduling of the requested meeting and the storing of all the meeting-specific data in the data store. The meeting-specific data includes information such as the scheduled time of the meeting or conference, the attendee list, the privileges and rules, the services requested (e.g., white boarding, audio/video, document sharing, etc.) during the scheduled meeting, etc. A drawback to conventional conferencing servers is their need for increasingly complex reservation systems and increasingly larger data stores as the use of these virtual meetings continue to increase.

It would be desirable to have a technique that allows for the scheduling, modification, and deletion of virtual meetings without the need for a central store to save the meeting-specific information.

### BRIEF DESCRIPTION OF THE DRAWINGS

FIG. 1 is a block diagram illustrating selected components typically incorporated in at least some of the computer systems on which various embodiments of the meeting endpoint may be implemented.

FIG. 2 is a block diagram illustrating an environment in which the meeting endpoint may operate.

FIG. 3 is a diagram illustrating elements of a master token, according to some embodiments.

FIG. 4 is a diagram illustrating elements of a forward token, according to some embodiments.

FIG. 5 is a diagram illustrating the interactions between end users and the meeting endpoint to schedule and join a meeting, according to some embodiments.

FIG. 6 is a diagram illustrating the interactions between end users and the meeting endpoint to obtain a forward token, according to some embodiments.

FIG. 7 is a diagram illustrating the interactions between end users and the meeting endpoint to modify a scheduled meeting, according to some embodiments.

### DETAILED DESCRIPTION

A conference room endpoint facility (also referred to herein as “the facility,” “conference room endpoint,” or “meeting endpoint”) enables a user to schedule conferences (also referred to herein as “meetings”) directly with the conference room endpoint facility and manage the scheduled conferences in an asynchronous manner without the need for a central data store to save the conference-specific information. For each scheduled meeting, the meeting data is stored locally with each invited meeting attendee. At the time of joining a scheduled meeting, each attendee presents its copy of the meeting data to the conference room endpoint facility. The conference room endpoint facility validates the meeting data and, upon validating the meeting data, admits the submitting meeting attendee into the meeting.

In some embodiments, the meeting endpoint is implemented as a component of a conferencing server, and includes logic to authenticate and authorize meeting organizers to schedule meetings, and authorized meeting attendees to join scheduled meetings. For example, a conference organizer wanting to schedule a conference can use a client to send to the meeting endpoint a request to schedule the conference. The client also sends the conference-specific details to the meeting endpoint. Upon receiving the request, the meeting endpoint places the conference-specific information into a “blob,” also known as a token. The meeting endpoint then signs the token and returns the signed token back to the client.

The conference organizer may then send or forward the token, along with a meeting invitation to all the conference attendees. In some embodiments, the conference organizer can use conventional calendaring software applications, such as MICROSOFT OUTLOOK, to both communicate with the meeting endpoint and to invite the conference attendees. Embedding the communications with the meeting endpoint within the calendaring software application provides for the abstraction of the communication from the end user.

Each conference invitee receives from the conference organizer the meeting invitation and the token. In order to join or attend the conference, each invitee presents the token to the meeting endpoint. Upon receiving the token, the meeting endpoint opens the token and validates the invitee that submitted the token. Upon validating the invitee that submitted token, the meeting endpoint admits the invitee into the conference as an attendee.

In some embodiments, the meeting endpoint utilizes a “waiting area,” such as a lobby, to hold invitees in the instance the specified conference has not begun. For example, a conference may start when the conference organizer, or a participant designated by the organizer, joins the conference. If an invitee presents the token prior to the conference having started, the meeting endpoint places the invitee in the waiting area until the specified conference is started. When the specified conference begins, the meeting endpoint admits the invitee into the conference, for example, as an attendee.

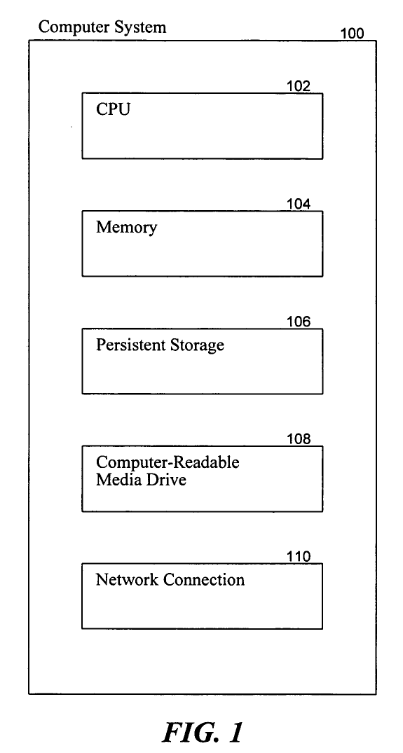

FIG. 1 is a block diagram illustrating selected components typically incorporated in at least some of the computer systems on which various embodiments of the meeting endpoint may be implemented. These computer systems 100 may include one or more central processing units (“CPUs”) 102 for executing computer programs; a computer memory 104 for storing programs and data—including data structures—while they are being used; a persistent storage device 106, such as a hard drive, for persistently storing programs and data; a computer-readable media drive 108, such as a CD-ROM drive, for reading programs and data stored on a computer-readable medium; and a network connection 110 for connecting the computer system to other computer systems, such as via the Internet, to exchange programs and/or data-including data structures. It will be appreciated that computer systems 100 may include one or more display devices for displaying program output, such as video monitors or LCD panels, and one or more input devices for receiving user input, such as keyboards, microphones, or pointing devices such as a mouse.

Embodiments of the meeting endpoint may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The meeting endpoint may be described in the general context of computer-readable instructions, such as program modules, executed by computer systems 100 or other devices. Generally, program modules include routines, programs, objects, components, data structures, etc. that perform particular tasks or implement particular abstract data types. Memory 104 and persistent storage device 106 are computer-readable media that may contain instructions that implement the meeting endpoint. It will be appreciated that memory 104 and persistent storage 106 may have various other contents in addition to the instructions that implement the meeting endpoint.

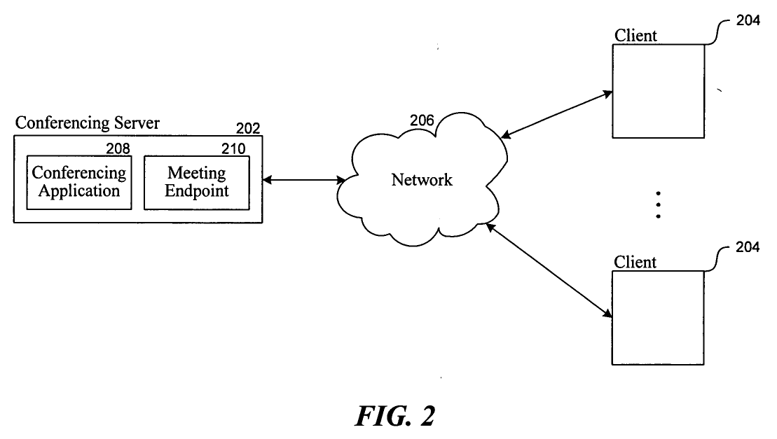

FIG. 2 is a block diagram illustrating an environment in which the meeting endpoint may operate. As depicted, the environment comprises a conferencing server 202 coupled to a plurality of clients 204 through a network 206. As used herein, the terms “connected,” “coupled,” or any variant thereof, means any connection or coupling, either direct or indirect, between two or more elements; the coupling of connection between the elements can be physical, logical, or a combination thereof.

In general terms, the conferencing server provides the conferencing services such as audio, video, data sharing, white boarding, instant messaging, etc. As depicted in FIG. 2, the conferencing server comprises a conferencing application 208 and a meeting endpoint 210. The conferencing application “hosts” the conferencing sessions, such as the virtual meetings, and provides the conferencing services to the conference or meeting participants. The meeting endpoint functions as an authentication authority that authenticates and authorizes meeting organizers and attendees to schedule and join meetings. In some embodiments, the meeting endpoint issues and authorizes the tokens that contain the meeting-specific information, and which are distributed to the clients in order to achieve distributed conference scheduling and management.

In general terms, the clients are applications that provide connectivity and access to the conferencing server and, in particular, the meeting endpoint. These applications rely on the various components of the conferencing server to perform the provided conferencing operations. In operation, users use the clients to connect to and utilize the services provided by the conferencing server. For example, the client may be a web browser application, a calendaring application, such as MICROSOFT OUTLOOK, etc., or other interface application that is suitable for connecting to and communicating with the conferencing server and the meeting endpoint.

The network is a communications link that facilitates the transfer of electronic content between, for example, the attached computers. In one embodiment, the network includes the Internet. It will be appreciated that the network may be comprised of one or more other types of networks, such as a local area network, a wide area network, a point-to-point dial-up connection, a cell phone network, and the like.

In the discussion that follows, various embodiments of the meeting endpoint are further described in conjunction with a variety of illustrative examples. It will be appreciated that the embodiments of the meeting endpoint may be used in circumstances that diverge significantly from these examples in various respects.

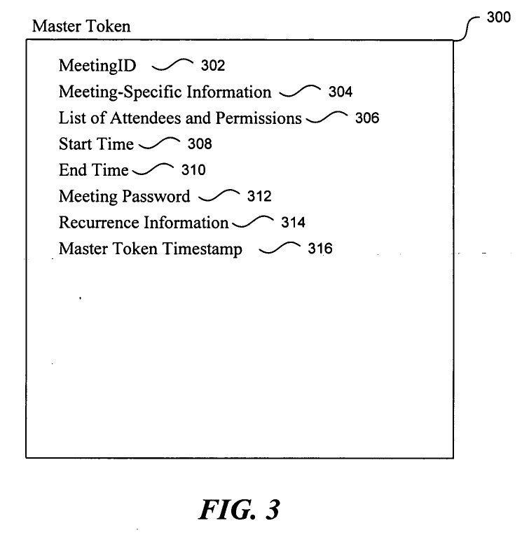

FIG. 3 is a diagram illustrating elements of a master token 300, according to some embodiments. The meeting endpoint creates a master token that contains conference-specific information for each scheduled conference. As depicted, the conference-specific information contained in the master token may include a meetingID 302, meeting-specific information 304, a list of attendees and permissions 306, a start time 308, an end time 310, a meeting password 312, recurrence information 314, and a master token timestamp 316.

The meetingID is a unique identifier that identifies the meeting represented by the particular master token. The meeting-specific information may specify a name of the meeting, a brief description of the meeting, a list of services (e.g., audio, video, data sharing, white boarding, instant messaging, etc.) requested for the meeting, and other data that is relevant to the meeting. The list of attendees and permissions identifies the list of persons (e.g., attendees) that are authorized to attend and participate in the meeting and their roles and permissions, if any. A meeting organizer, at the time of scheduling and/or modifying a meeting, may designate roles and permissions to one or more listed attendees that are authorized to participate in the meeting. For example, at the time of scheduling a meeting, the meeting organizer may give “forward” only permission to one or more listed attendees. These attendees will then be allowed to forward the meeting request to other meeting attendees—i.e., invite additional participants into the meeting. Similarly, the meeting organizer may give “conference modification” permission to one or more listed attendees. These attendees will then be allowed to modify the scheduled meeting. The meeting organizer may also assign roles (e.g., presenter, attendee, etc.) to the listed attendees.

The start time indicates the time the meeting is scheduled to start. The end time indicates the time the meeting is scheduled to end. The meeting password is optional, and if present, specifies a password that is required to gain admittance into the meeting. For example, a meeting organizer, at the time of scheduling and/or modifying a meeting, may have specified a password in order to schedule and conduct a secure, password-protected meeting. The meeting endpoint requires the attendees to provide the password along with the master token in order to join the meeting. In some embodiments, the meeting endpoint encrypts the password before placing the password in the master token. In some embodiments, the meeting password may be a password hash.

The recurrence information is optional, and if present, specifies a recurring schedule for the meeting. For example, a meeting organizer can schedule a meeting that recurs over time (e.g., every Friday, from 10 am to 11 am), and the meeting endpoint specifies the recurring schedule in the recurrence information. The master token timestamp indicates the time at which the meeting endpoint created the master token. The meeting endpoint uses the contents of the list of attendees and the master token timestamp to admit the attendees into the meeting. In some embodiments, in addition to being included in the list of attendees, the meeting endpoint only admits attendees into a meeting who submit tokens that contain a timestamp (e.g., either a master token timestamp or a forward token timestamp) that is the same as a timestamp (e.g., either a master token timestamp or a forward token timestamp) contained in the token submitted by the meeting organizer or other meeting attendee authorized to start the meeting. Forward tokens and forward token timestamps are further discussed below.

In some embodiments, the meeting endpoint uses the timestamps to prohibit possible misuse of older tokens. For example, if a person presents an older token, the meeting endpoint may place the person in a waiting area of the meeting only until such time a meeting attendee (e.g., meeting organizer or other attendee authorized to start the meeting) with a newer token (i.e., token with a later timestamp) joins or starts the meeting. At that time, the meeting endpoint can take appropriate action regarding the person who presented the older token. For example, the meeting endpoint may remove the person who submitted the older token from the waiting area. In other embodiments, the meeting endpoint allows the person or persons submitting older tokens to attend the meeting that was specified by the older token.

One skilled in the art will appreciate that one or more of the elements described above may be omitted in the master token. Moreover, the master token may include elements other than those described above.

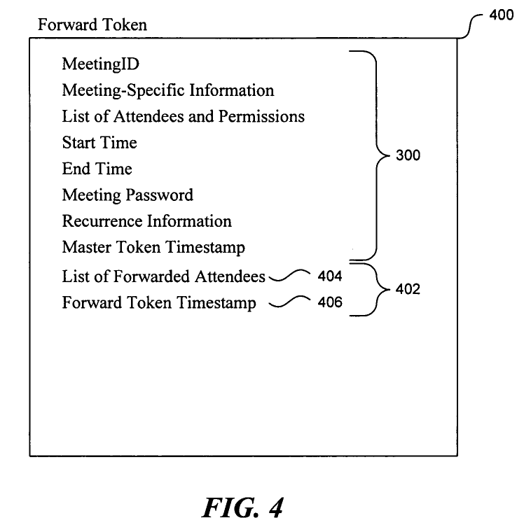

FIG. 4 is a diagram illustrating elements of a forward token 400, according to some embodiments. The meeting endpoint creates a forward token for use by authorized meeting attendees to invite other participants into a scheduled meeting. As depicted, the forward token comprises the master token and forwarding information 402, which comprises a list of forwarded attendees 404 and a forward token timestamp 406. The list of forwarded attendees identifies the list of additional attendees that are authorized to participate in the meeting. The list of forwarded attendees may also identify the roles and permissions, if any, for the additional attendees. The forward token timestamp indicates the time at which the meeting endpoint created the forward token. The forward token timestamp specifies a time that is later than the master token timestamp. In the case of forward tokens, in addition to being included in the list of forwarded attendees, the meeting endpoint admits attendees into a meeting who submit forward tokens that contain (1) a forward token timestamp that is later than the master token timestamp contained in the forward token, and (2) a master token timestamp that is the same as a master token timestamp contained in the token submitted by the meeting organizer or other authorized meeting attendee to start the meeting. The meeting endpoint may create a forward token for a scheduled meeting by appending the forwarding information to the master token that corresponds to the scheduled meeting.

In some embodiments, the meeting endpoint signs the token—i.e., the master token and the forward token—using, for example, a symmetric key, before providing or returning the token to, for example, the conference organizer. By signing the token, the meeting endpoint is able to verify, for example, when the token is submitted with a request to join a meeting, that the meeting endpoint originally created and issued the token and that the token has not been modified. The meeting endpoint may periodically refresh the keys used to sign the tokens. In some embodiments, the meeting endpoint may encrypt the token using any of a variety of well-known encryption techniques. The meeting endpoint may also encrypt other information contained in the token. For example, the meeting endpoint may encrypt the meeting password (or password hash) for password-protected meetings.

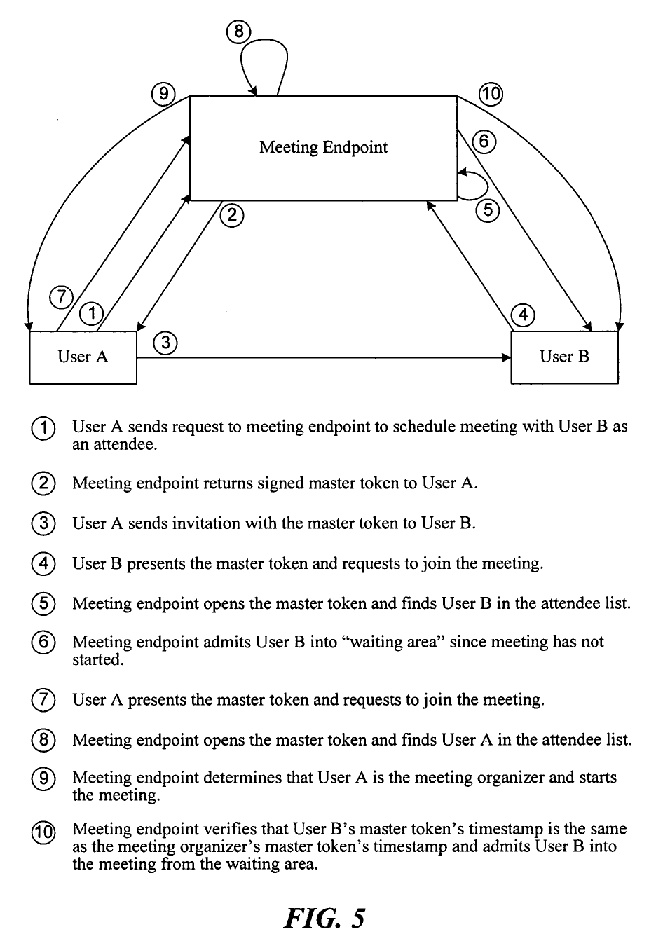

FIG. 5 is a diagram illustrating the interactions between end users and the meeting endpoint to schedule and join a meeting, according to some embodiments. By way of example, User A uses a client to send a request to the meeting endpoint to schedule a meeting with User B as an authorized attendee (stage 1). User A may send other meeting-specific information, such as the time of the meeting, the duration of the meeting, the conferencing services requested for the meeting, any password if the meeting is to be a secure password, any roles or permissions, etc., to the meting endpoint. The meeting endpoint may check to determine that the meeting can be scheduled as requested. If the meeting can be scheduled, the meeting endpoint creates a master token for the requested meeting, signs the master token, and returns the signed master token to User A (stage 2).

Upon receiving the master token, User A sends an invitation to attend the meeting and the master token to User B (stage 3). For example, User A may send an email message with the master token as an attachment to User B inviting User B to attend the meeting. If the meeting is password-protected, User A can call or otherwise communicate the required password to User B. In other embodiments, User A can invite User B to attend the meeting utilizing other forms of communication such as, by way of example, instant messaging, telephone, face-to-face, text messaging, and other forms of in-band and out-of-band communication. User A may provide the master token at the time of inviting User B or, alternatively, provide User B the master token in a separate communication. In some embodiments, User A can publish this token at a well known location and then anyone can join the meeting by going to the well known location and using the token. This may be useful for “public meetings”—e.g., if marketing wants to have a meeting to demonstrate the features of a product, they may want everyone who is interested to be able to join. In this instance, the token may contain a flag that indicates that anyone presenting this token should be permitted to join the meeting. For example, User A requests this feature—e.g., the inclusion of this flag—when requesting to schedule the meeting.

At approximately the time of the scheduled meeting, User B uses a client and presents the master token to the meeting endpoint and requests to join the meeting (stage 4). The meeting endpoint opens the master token and verifies that User B is included in the attendee list and, thus, authorized to join the requested meeting (stage 5). The meeting endpoint checks to determine if the requested meeting has been started—i.e., the meeting is in progress. Having determined that the requested meeting has not been started, the meeting endpoint admits User B into a designated waiting area for the requested meeting (stage 6).

In other embodiments, for example, in embodiments where a waiting area may not be provided, the meeting endpoint admits User B into the requested meeting. In certain instances, User B may be the only participant in this meeting if no other attendees request to join this meeting. For example, the meeting organizer (User A) may have changed the meeting by, for example, removing User B from the meeting attendee list and obtained a new master token with a new meetingID. Here, people with the maser token having the old meetingID can still join the identified meeting, but they would be in a different meeting than the people who received the new master token. So if User A has removed User B from the meeting and re-distributed the new token to Users C and D, at join time, Users A, C and D would join a meeting with one meetingID, and User B would be in a meeting with the old meeting ID all by him or herself. Therefore, even if User B unlawfully obtained the master token and gained admittance into the meeting, the meeting will not be compromised as long as the meeting organizer modified the meeting, thus obtaining a new master token with a new or different meetingID, and informed the desired attendees of the modification to the meeting—i.e., issued the new master token to the desired attendees.

Subsequently, User A uses a client and presents the master token to the meeting endpoint and requests to join the meeting (stage 7). The meeting endpoint opens the master token and verifies that User A is included in the attendee list and, thus, authorized to join the requested meeting (stage 8). The meeting endpoint also determines, for example, from the assigned roles, that User A is the meeting organizer and starts the requested meeting (stage 9). The meeting endpoint checks the waiting area and determines that User B is waiting for the meeting to start. The meeting endpoint verifies that User B's master token's timestamp is the same as User A's (e.g., the meeting organizer's) master token's timestamp and admits User B into the meeting from the waiting area.

In other embodiments, the meeting endpoint may authenticate a user—e.g., attendee—that requests to join a meeting to verify that the user is who the user purports to be. For example, the meeting endpoint may use any of a variety of well-known authentication techniques, such as, by way of example, Kerberos, etc., to ensure that the user is who the user purports to be and not an imposter. Alternatively, authentication-specific information may be stored in the token.

In some embodiments, in cases where the size of the token presents a problem, the signature of the token may be distributed and stored by the clients. The clients may then construct the token, for example, at join time and present the constructed and signed token to the meeting endpoint along with the signature. The endpoint may then validate the accuracy of the token by validating it against the signature. In some embodiments, the token may be compressed using any of a variety of well-known compression techniques.

One skilled in the art will appreciate that, for this and other processes, interactions and methods disclosed herein, the functions performed in the processes, interactions and methods may be implemented in differing order. Furthermore, the outlined steps are only exemplary, and some of the steps may be optional, combined into fewer steps, or expanded into additional steps without detracting from the essence of the invention.

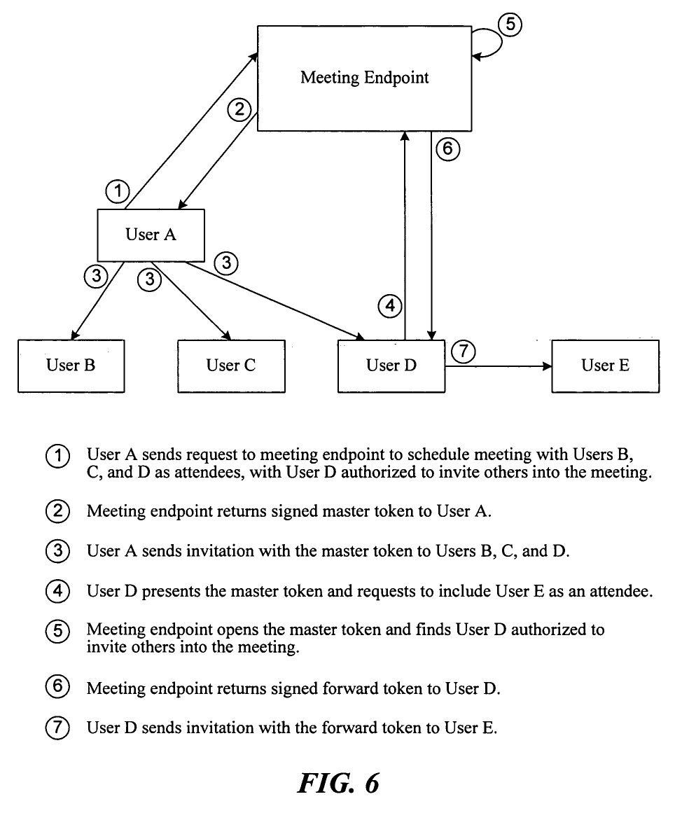

FIG. 6 is a diagram illustrating the interactions between end users and the meeting endpoint to obtain a forward token, according to some embodiments. By way of example, User A uses a client to send a request to the meeting endpoint to schedule a meeting with User B, User C, and User D as authorized attendees, with User D authorized to invite other attendees to the meeting (stage 1). The meeting endpoint may check to determine that the meeting can be scheduled as requested, and if the meeting can be scheduled, the meeting endpoint creates a master token for the requested meeting, signs the master token, and returns the signed master token to User A (stage 2).

Upon receiving the master token, User A sends an invitation to attend the meeting and the master token to each of Users B, C, and D (stage 3). Subsequently, wanting to invite another attendee—i.e., User E—into the meeting, User D presents the master token to the meeting endpoint and requests to include User E as an authorized attendee of the meeting (stage 4). The meeting endpoint opens the master token and verifies, for example, from the list of attendees and roles, that User D is authorized to invite others into the meeting (stage 5). The meeting endpoint creates a forward token for the requested meeting, signs the forward token, and returns the signed forward token to User D (stage 6). In some embodiments, the forward token identifies User E as an authorized attendee of the meeting, for example, in the list of forwarded attendees. In other embodiments, the list of forwarded attendees in the forward token may identify all the authorized attendees of the meeting—e.g., User A, User B, User C, User D, and User E.

Upon receiving the forward token, User D sends an invitation to attend the meeting and the forward token to User E (stage 7). Subsequently, for example, approximate to the time of the scheduled meeting, Users A, B, and C can each present the master token to the meeting endpoint and request to join the meeting, and Users D and E can each present the forward token to the meeting endpoint and request to join the meeting.

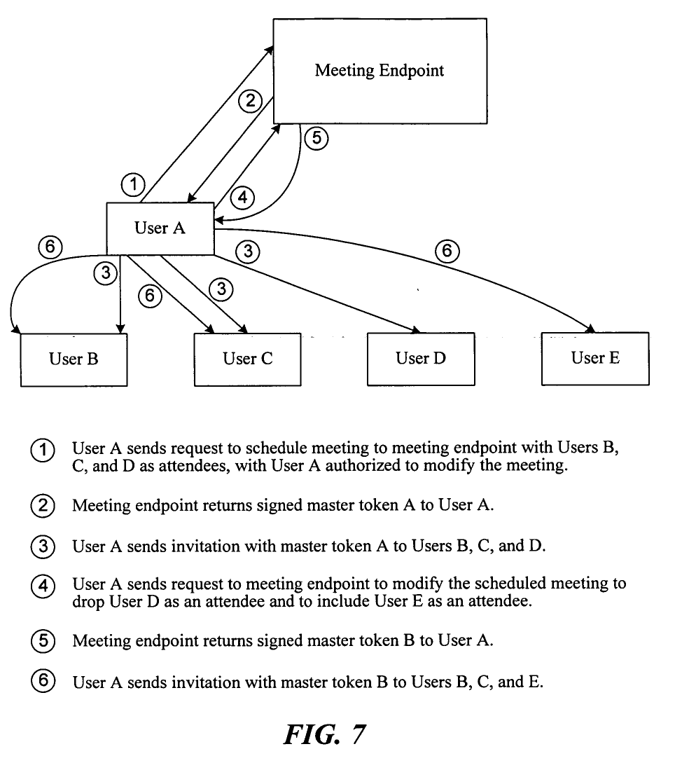

FIG. 7 is a diagram illustrating the interactions between end users and the meeting endpoint to modify a scheduled meeting, according to some embodiments. By way of example, User A uses a client to send a request to the meeting endpoint to schedule a meeting with User B, User C, and User D as authorized attendees, with User A authorized to modify the meeting (stage 1). The meeting endpoint may check to determine that the meeting can be scheduled as requested, and if the meeting can be scheduled, the meeting endpoint creates a master token A for the requested meeting, signs master token A, and returns the signed master token A to User A (stage 2).

Upon receiving master token A, User A sends an invitation to attend the meeting and master token A to each of Users B, C, and D (stage 3). Subsequently, wanting to modify the scheduled meeting, User A presents master token A to the meeting endpoint and requests to modify the scheduled meeting—i.e., the meeting represented by master token A. In particular, User A requests to modify the scheduled meeting to drop User D as an authorized attendee and to include User E as an authorized attendee of the meeting (stage 4). The meeting endpoint opens master token A and verifies, for example, from the list of attendees and roles, that User A is authorized to modify the meeting. Subsequent to verifying that User A is authorized to modify the meeting, the meeting endpoint creates a new master token B for the modified meeting, signs master token B, and returns the signed master token B to User A (stage 5). Upon receiving master token B, User A sends an invitation to attend the modified meeting and master token B to each of Users B, C, and E (stage 6). User A may inform Users B, C, and E of the modification to the previously scheduled meeting. User A may also notify User D that the originally scheduled meeting, as represented by master token A, has been canceled and will not be conducted.

Subsequently, for example, approximate to the time of the scheduled meeting, Users A, B, C, and E can each present master token B to the meeting endpoint and request to join the meeting. In the instance that User D presents master token A to the meeting endpoint and requests to join the meeting—i.e., the meeting represented by master token A—the meeting endpoint may create a meeting having User D as the only participant. Here, User D is placed in a different meeting—i.e., the meeting represented by master token A—than the meeting being attended by Users A, B, C, and E—i.e., the meeting represented by mater token B.

In other embodiments, for example, where the meeting endpoint utilizes waiting rooms, User D may be placed in a waiting room. The meeting endpoint may subsequently remove User D from the waiting room if, for example, the requested meeting does not start within a predetermined amount of time.

One skilled in the art will appreciate that the meeting modification role or authority is not limited to the meeting organizer, but may be given to any one or more authorized meeting attendees.

In some embodiments, the meeting endpoint may maintain a limited data store in order to perform some amount of resource management and reservation-based booking. For example, the meeting endpoint may store free/busy information to avoid “double booking” of meetings in one time slot. In another example, the meeting endpoint may store configuration information such as bandwidth optimizations, network traffic, etc. For example, a conferencing server administrator may configure the conferencing server to conduct a maximum of 10 meetings in any hour or to have a maximum of 100 attendees in the meetings at any given time. The meeting endpoint may store this configuration information in its data store to ensure that the conferencing server operates according to the specified configuration.

In some embodiments, the facility allows for easily integrating various calendaring features. For example, the facility allows for the integration of the “propose new time” feature provided in calendaring applications, such as MICROSOFT OUTLOOK, etc. This may simply be implemented in the facility as a meeting modification request, and every attendee may by default have permission to propose new time for a scheduled meeting.

One skilled in the art will appreciate that the number of users—e.g., meeting attendees—depicted in the interaction examples above are only for simplicity and ease of explanation and is not meant as a limitation to the actual number of meeting attendees, and that there can be a different number of meeting attendees. One skilled in the art will also appreciate that the number of forward token requests and/or meeting modifications depicted in the interaction examples above are only for simplicity and ease of explanation and is not meant as a limitation of the number of forward token requests and/or meeting modifications that may occur, and that there can be a different number of forwarded token requests and/or a different number of meeting modifications.

From the foregoing, it will be appreciated that embodiments of the invention have been described herein for purposes of illustration, but that various modifications may be made without deviating from the spirit and scope of the invention. Accordingly, the invention is not limited except in accordance with elements explicitly recited in the appended claims.

We claim:

1. A computer-readable medium whose contents cause a computer to:
receive a request from a client to schedule a meeting;
receive from the client information specific to the requested meeting;
in response to receiving the request and the information specific to the meeting, generate a token corresponding to the scheduled meeting, the token comprising the meeting-specific information;
sign the token; and
return the signed token to the client,
such that the signed token allows for the distributed management of the scheduled meeting.

2. The computer-readable medium of claim 1, wherein the meeting-specific information comprises a meeting password.

3. The computer-readable medium of claim 1, wherein the meeting-specific information comprises a list of attendees and permissions.

4. The computer-readable medium of claim 1, wherein the meeting-specific information indicates that at least one attendee in the list of attendees is authorized to invite others into the scheduled meeting.

5. The computer-readable medium of claim 1, wherein the meeting-specific information indicates that at least one attendee in the list of attendees is authorized to modify the scheduled meeting.

6. The computer-readable medium of claim 1, wherein the meeting-specific information comprises a timestamp that indicates the time the token was generated.

7. The computer-readable medium of claim 1, wherein the meeting-specific information comprises recurrence information.

8. The computer-readable medium of claim 1 further comprising contents that cause the computer to:
receive from a second client the token and a request to join the scheduled meeting, the request to join the scheduled meeting comprising an identity of a meeting attendee;
check the token to verify that the meeting attendee is authorized to join the scheduled meeting; and
if the meeting attendee is an authorized meeting attendee, determine if the scheduled meeting has started;
in response to determining that the scheduled meeting has not started, admit the authorized meeting attendee into a waiting area; and
in response to determining that the scheduled meeting has started, verify that at least one timestamp in the authorized meeting attendee's token is the same as at least one timestamp contained in a token used to start the scheduled meeting, and if at least one timestamp in the authorized meeting attendee's token is the same as at least one timestamp contained in the token used to start the scheduled meeting, admit the authorized meeting attendee into the scheduled meeting.

9. The computer-readable medium of claim 6 further comprising, if at least one timestamp in the authorized meeting attendee's token is not the same as at least one timestamp contained in the token used to start the scheduled meeting, do not admit the authorized meeting attendee into the scheduled meeting.

10. The computer-readable medium of claim 6 further comprising:
receive from a second client the token and a request to include one or more other attendees to the scheduled meeting, the request to include the one or more other attendees to the scheduled meeting comprising an identity of a meeting attendee;
check the token to verify that the meeting attendee is authorized to invite the one or more other attendees to the scheduled meeting; and
if the meeting attendee is authorized to invite others to the scheduled meeting:
generate a forward token corresponding to the scheduled meeting, the forward token comprising a list of forwarded attendees identifying the one or more other attendees;
sign the forwarded token; and
return the signed forwarded token to the second client,
such that the signed forwarded token may be used to invite the one or more other attendees to the scheduled meeting.

11. One or more computer memories collectively containing a signed token for a scheduled meeting, the signed token comprising information specific to the scheduled meeting,
such that the contents of the signed token may be used to authenticate a user submitting the signed token as an authorized attendee of the scheduled meeting.

12. The computer memories of claim 11, wherein the signed token may be used to create a second signed token for the scheduled meeting, the second signed token comprising the information specific to the scheduled meeting contained in the signed token and additional information specific to the scheduled meeting.

13. The computer memories of claim 12, wherein the second signed token may be passed from a first user to a second user, and further wherein both the first user and the second user can use the second signed token to join the scheduled meeting.

14. The computer memories of claim 11, wherein the signed token may be passed from a first user to a second user, and further wherein both the first user and the second user can use the signed token to join the scheduled meeting.

15. A method in a computing system for scheduling conferences without requiring the use of a central store to store the conference-specific information, the method comprising:
receiving from a client a request to schedule a conference;
receiving from the client information specific to the requested conference;
in response to receiving the request and the information specific to the conference, generating a blob corresponding to the scheduled conference, the blob comprising the conference-specific information;
signing the blob; and
returning the signed blob to the client.

16. The method of claim 15, wherein the meeting-specific information comprises a conference password that is required to join the scheduled conference.

17. The method of claim 15, wherein the meeting-specific information comprises a timestamp for use in admitting authorized meeting attendees into the scheduled conference.

18. The method of claim 15, wherein the meeting-specific information comprises at least one service requested for the scheduled conference.

19. The method of claim 15, wherein the meeting-specific information comprises an identity of a user authorized to invite others to the scheduled conference.

20. The method of claim 15, wherein the meeting-specific information comprises an identity of a user authorized to modify the scheduled conference.
